(19) United States
(12) Patent Application Publication
(10) Pub. No.: US 2004/0206785 A1
(43) Pub. Date: Oct. 21, 2004

(54) Shaker

(76) Inventor: Leif Einar Stern, Lomma (SE)

Correspondence Address: Tarolli Sundheim Covell & Tummino, Suite 1111, 526 Superior Avenue, Cleveland, OH, 44114-1400, US

(21) Appl. No.: 10/488,175

(22) PCT Filed: Aug. 15, 2002
(86) PCT No.: PCT/SE02/01454

(30) Foreign Application Priority Data
Sep. 7, 2001 (SE) 0102964-4

(51) Int. Cl. G01F 11/28

(52) U.S. Cl. 222/434

(57) ABSTRACT

The present invention relates to a shaker for sprinkling granules, preferably salt. The shaker (1) comprises a screen-like member (7) which is mounted movable in vertical direction relative to such lower parts (5) of the shaker (1) which define a lower space (8) in which granules (2) are collected or vice versa, for being able to set the screen-like member (7) such that downwardly directed portions (7a) thereof can be set at different distances (e.g. A or B) from the bottom (9) of the lower space (8). Thereby, it is achieved that the lower space (8) can be brought to contain different amounts of granules (2).

The present invention relates to a shaker for sprinkling granules, preferably salt. The shaker comprises upper parts defining at least one supply space for granules and lower parts with at least one outfeed opening for sprinkling granules out of the shaker in a downward direction by imparting sprinkling movements to the shaker. At the bottom of the shaker there is provided at least one screen-like member forming a bottom for the supply space and covering the outfeed opening. The lower parts of the shaker define at least one lower space which is located around the outfeed opening and the lower space is closed down below by means of the bottom and is provided at the top with an upper opening. Downwardly directed portions of the screen-like member are directed downwards towards and preferably into the lower space. The lower space communicates via a through-flow gap at an outer side of the downwardly directed portions of the screen-like member with the supply space such that granules can flow from said supply space down into the lower space. The lower space communicates via a discharge gap, which relative to a centre line along the shaker is located at an inner side of said downwardly directed portions, with the outfeed opening such that granules via the discharge gap can pass from the lower space to the outfeed opening.

Shakers of the abovementioned type are already known from e.g. U.S. Pat. Nos. 1,682,804, 2,252,835 and 5,429,281. None of these prior art shakers permits variation of the amount of granules sprinkled at each sprinkling occasion.

The object of the present invention has been to improve prior art shakers such that the amount of granules sprinkled at each sprinkling occasion can be varied. This is arrived at by providing the shaker primarily with the characterizing features of subsequent claim 1.

Since the screen-like member of the shaker is movable relative to a lower space, it is possible to bring the lower space to contain different amounts of granules. The farther down the screen-like member is set, the smaller amount of granules can be accommodated in the lower space and the farther up the screen-like member is set, the larger amount of granules can be accommodated in the lower space.

The invention will be further described below with reference to the accompanying drawings, in which

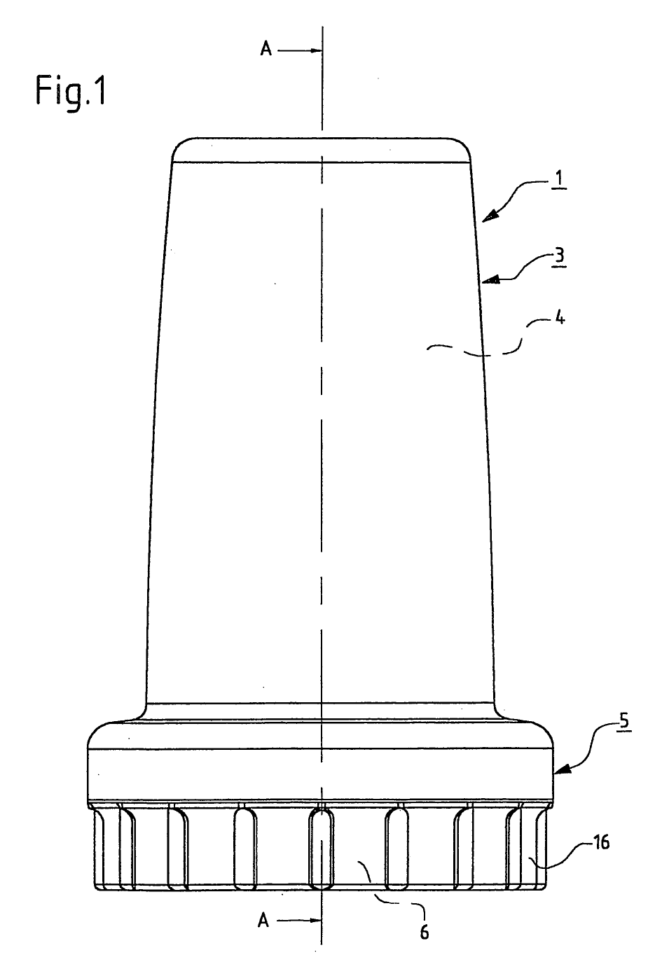

FIG. 1 is a side view of a shaker according to the invention;

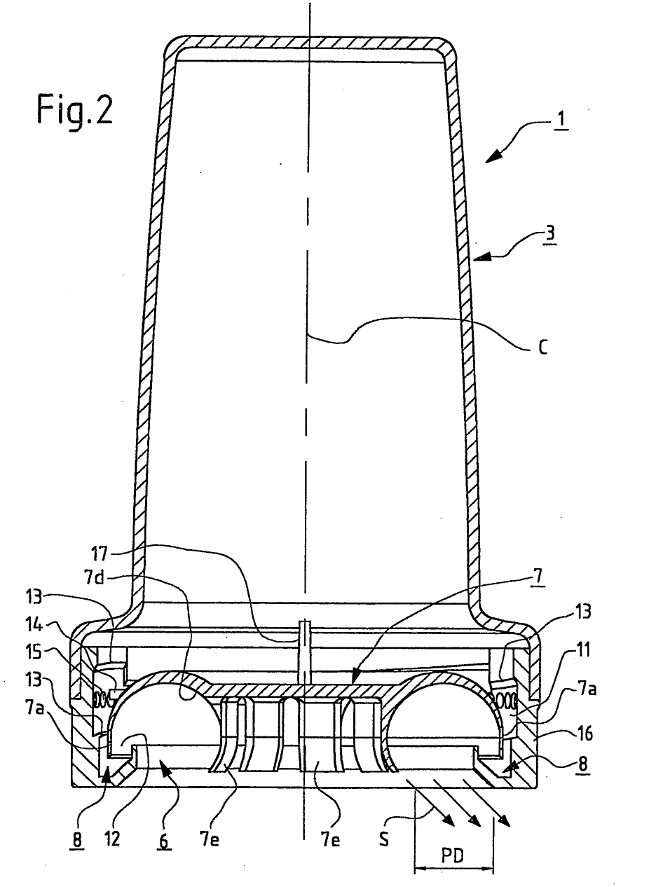

FIG. 2 is a section along the line A-A through the shaker of FIG. 1;

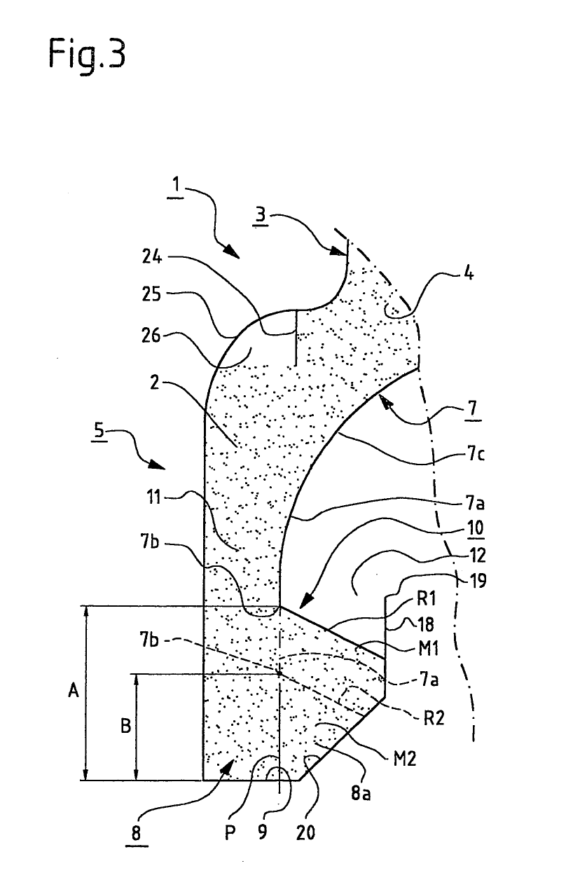

FIG. 3 illustrates schematically an enlarged portion of lower parts with a lower space of the shaker of FIG. 1; and

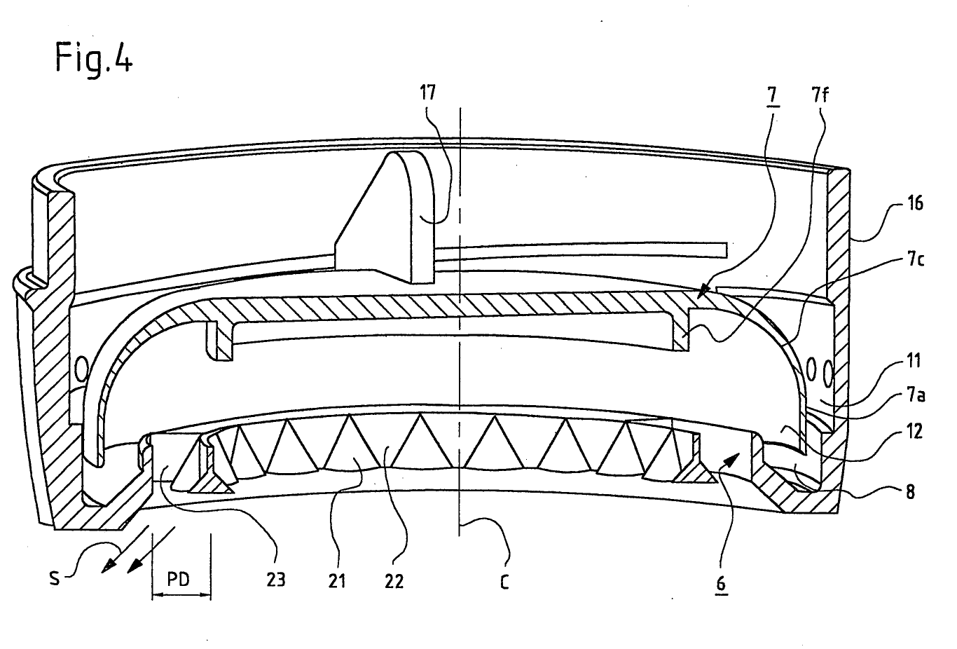

FIG. 4 illustrates with a section lower parts of an alternative embodiment of the shaker according to the invention.

The embodiment of the shaker 1 according to the invention illustrated in FIGS. 1-3, is adapted for sprinkling granules 2, preferably salt, on foodstuff. Said shaker 1 comprises upper parts 3, defining at least one supply space 4 for the granules 2, and lower parts 5 with at least one outfeed opening 6 for sprinkling granules 2 out of the shaker 1 in a downward direction. This is done by imparting sprinkling movements to the shaker 1, normally first a movement upwards and then a movement downwards, at each sprinkling occasion.

At the bottom of the shaker 1 there is provided at least one screen-like member 7 forming a bottom for the supply space 4 and covering the outfeed opening 6 such that granules 2 can not unintentionally fall out of said supply space 4.

The lower parts 5 of the shaker 1 define at least one lower space 8 which is located around the outfeed opening 6 and which is closed down below by means of a bottom 9 and having an upper opening 10. The screen-like member 7 has downwardly directed portions 7a which are directed downwards towards and preferably into the lower space 8.

The lower space 8 communicates via a through-flow gap 11 at an outer side of said downwardly directed portions 7a with the supply space 4 such that granules 2 can flow from said supply space 4 down into the lower space 8.

The lower space 8 communicates via a discharge gap 12, which relative to a centre line C which runs along the shaker 1 is located at an inner side of the downwardly directed portions 7a, with the outfeed opening 6 such that granules 2 via the discharge gap 12 can pass from the lower space 8 to the outfeed opening 6.

In order to see to that the lower space 8 can contain different amounts of granules, the screen-like member 7 is mounted movable in vertical direction relative to the lower parts 5 defining the lower space 8, or are said lower parts 5 instead mounted movable in vertical direction relative to the screen-like member 7. Thus, the screen-like member 7 can be set at different heights between an upper position (shown with solid lines in FIG. 3) in which a lower edge 7b of the downwardly directed portions 7a is situated at a distance A from the bottom 9 of the lower space 8, and a lower position (shown with broken lines in FIG. 3) in which the downwardly directed portions 7a are situated at a smaller distance B from said bottom 9.

If the screen-like member 7 is set e.g. in the upper position at the distance A from the bottom 9, the granules 2 will be filled into the lower space 8 until an inner pocket 8a thereof has been filled up to the lower edge 7b from which it is sloping downwards/inwards at an angle of repose R1. If this pocket 8a is limited in outwards direction by an imaginary vertical plane P, an amount M1 will in said case be collected or gathered in the pocket 8a beneath the discharge gap 12 and this amount M1 will be brought to leave the lower space 8 at a sprinkling occasion. If the screen-like member 7 instead is set at a lower level, e.g. in the lower position at the distance B from the bottom 9, granules 2 will be filled into the lower space 8 until the inner pocket 8a has been filled up to the lower edge 7b, but since this lower edge 7b in said latter position is situated closer to the bottom 9, a smaller amount M2 will be gathered or collected in the pocket 8a, and this smaller amount of granules 2 will slope downwards/inwards at an angle of repose R2 (shown with broken lines in FIG. 3). In said latter case the smaller amount M2 may thus be sprinkled at a sprinkling occasion.

In the same manner various amounts of granules 2 (which are smaller than the amount M1 and larger than the amount M2) can be gathered or collected in the inner pocket 8a.

Thus, the abovementioned possibility to gather or collect a sprinkable amount of granules 2 set for each sprinkling occasion in the pocket 8a, has the advantage that one can determine exactly the amount of granules 2 to be sprinkled or spread at each sprinkling occasion. Setting the screen-like member 7 in different positions relative to the lower space 8 further means that the amount sprinkled at each sprinkling occasion can be varied.

The screen-like member 7 can be set in vertical direction by imparting thereto a rotary motion relative to the lower parts 5 defining the lower space 8.

Thus, the lower parts 5 of the shaker 1 may have at least one helical groove 13 which is rotatably engaged by the screen-like member 7.

For being able to set the screen-like member 7 in various definite height or vertical positions, said screen-like member and the lower parts 5 of the shaker 1 may be provided with co-operating stepping members which permit step-wise rotation of the screen-like member 7 relative to said lower parts 5. These stepping members may consist of flanges 14 which are provided, directed outwardly, on the screen-like member 7, and these flanges 14 may co-operate with a rim of projections 15 located on the inner side of the lower parts 5.

The lower parts 5 of the shaker 1 defining the lower space 8 may be an annular member 16 which is removably attached to the upper parts 3 of the shaker 1. The annular member 16 can be attached by a snap-in action or screwed onto the upper parts 3.

The screen-like member 7 may on an upper side have at least one flange 17 which is accessible when the annular member 16 been removed from the upper parts 3 of the shaker 1 together with the screen-like member 7 for being able to grip or engage the flange 17 and thereby rotate the screen-like member 7 relative to the annular member 16 and in this way set said screen-like member 7 in different height or vertical positions relative to the lower space 8.

An alternative embodiment may be that on the screen-like member 7 there are downwardly directed means which can be grasped or engaged via the outfeed opening 6 for rotation of the screen-like member 7 relative to the lower parts 5, whereby height adjustment of said screen-like member 7 may occur relative to the lower space 8 without having to dismount or take the shaker 1 apart.

At the embodiments of the shaker 1 illustrated in the figures, the lower space 8 may be limited in inwards direction (relative to the longitudinal centre line C through the shaker 1) by an inner wall 18, the upper edge 19 of which defines upper portions of the outfeed opening 6. Also, at least lower portions of an inner side 20 of the inner wall 18, closest to said bottom 9 of the lower space 8, may be directed obliquely upwards/inwards.

At the shaker 1 shown, the screen-like member 7 may transform, via arcuate portions 7c, into the downwardly directed portions 7a. The bottom side of these arcuate portions 7c may define sliding surfaces along which the granules 2 slide when they are thrown out of the lower space 8.

On and/or beneath the screen-like member 7 or on other suitable locations there may be spreading surfaces and/or spreading members for spreading or scattering the granules 2 coming from the lower space 8 in, inter alia, outwards direction (i.e. in the spreading direction S) relative to the centre line C, such that the granules 2 are spread out over an area beneath the shaker 1 which is not too limited. These spreading surfaces and/or spreading members may be located and designed in various ways. In the embodiment of FIG. 2, certain such spreading surfaces and spreading members are shown, while in the embodiment of FIG. 4 other spreading surfaces and spreading members are shown. Thus, the embodiment of FIG. 2 illustrates spreading members 21 which are defined by a downwardly directed extension 7d of the screen-like member 7. Within said extension 7d there is located a rim of downwardly and down below, outwardly directed spreading members 7e. These are adapted to spread or scatter downwardly flowing granules 2 in downwards direction through peripheral portions PD of the outfeed opening 6. Some of the granules 2 may flow in inwards/downwards direction through spaces between said spreading members 7e.

At the embodiment of FIG. 4, the screen-like member 7 has, within the arcuate portions 7c, a downwardly directed spreading member in the form of a downwardly directed, annular flange 7f which directs the flow of granules through said peripheral portions PD of the outfeed opening 6. In said peripheral portions PD of the outfeed opening 6 there are provided or located spreading members 21 for spreading the granules 2 flowing downwards through said peripheral portions PD, in a direction downwards/outwards and downwards/inwards. These spreading members 21 may e.g. be conical in shape and be located with the point facing upwards. They may be located in a rim on a ring 22 and this ring 22 may be attached to the inner wall 18 via mounting ears 23. The annular flange 7f may have a somewhat smaller diameter than the outfeed opening 6 and the ring 22 may have a smaller diameter than the outfeed opening 6 but a larger diameter than the annular flange 7f.

A sprinkling occasion can mean that the shaker 1 initially is lifted quickly in vertically upwards direction. Due to this lifting movement, the amount of granules 2 (e.g. the amount M1 or M2) will be thrown upwards out of the pocket 8a, while those portions of the granules 2 located in an outer part of the lower space 8 on the outside of said plane P will be thrown upwards in the through-flow gap 11, which however can be prevented by providing a flow resisting member 24 in the upper parts 3, e.g. above the through-flow gap 11. This flow resisting member 24 may be a downwardly directed, annular flange, which, with an inwardly directed wall portion 25 of the upper parts 3 vertically above the through-flow gap 11, defines a downwards open but upwards closed space 26 in which granules 2 are prevented from being thrown upwards and eventually into the supply space 4 when the shaker 1 is quickly lifted. Hereby, there are granules 2 near the pocket 8a which quickly can fill said pocket 8a after a quick lifting movement of the shaker 1.

At said sprinkling occasion, the shaker 1 may, after quick lifting thereof, be lowered quickly in a vertically downwards direction. Hereby, the amount of granules 2 which during the initial lifting movement is thrown out of the inner pocket 8a will be thrown downwards by the screen-like member 7. At e.g. the embodiment of FIG. 4, the granules 2 will be thrown towards the spreading members 21 by means of the screen-like member 7 and will be spread or scattered, inter alia, obliquely outwards in the spreading direction S relative to said centre line C, by said spreading members 21.

Thereafter, said sprinkling occasion is concluded and a certain amount of granules has been spread or sprinkled over an area which is not limited to parts having a substantially smaller diameter than the outfeed opening 6, but on the contrary preferably has a larger diameter than said outfeed opening 6.

The invention is not limited to the embodiments described above and shown in the drawings. As examples of other embodiments of the shaker 1 it should be noted that the shaker 1 may consist of another number than three members even if it is preferred that the shaker consists of three members. The spreading surfaces or spreading members may be located and/or designed in other ways. The upper parts 3 of the shaker 1 may at least in part be made of a transparent material so that you can see how much granule material there is in the supply space 4, the shaker 1 may be used for other granules than salt and it may consist of a suitable plastic material. Furthermore, there may be a setting scale (not shown) showing in which height or vertical position the screen-like member 7 is set relative to the lower space 8. There may also be a direction indicator showing in which direction a member 16 of the shaker 1 shall be screwed or rotated for raising or lowering said member 16.

1. Shaker for sprinkling granules, preferably salt,
wherein the shaker (1) comprises upper parts (3) defining at least one supply space (4) for granules,
wherein the shaker (1) comprises lower parts (5) with at least one outfeed opening (6) for sprinkling granules (2) out of the shaker (1) in a downward direction by imparting sprinkling movements to the shaker (1),
wherein at the bottom of the shaker (1) there is provided at least one screen-like member (7) forming a bottom for the supply space (4) and covering the outfeed opening (6),
wherein lower parts (5) of the shaker (1) define at least one lower space (8) which is located around the outfeed opening (6),
wherein the lower space (8) is closed down below by means of the bottom (9) and is provided at the top with an upper opening (10), wherein downwardly directed portions (7a) of the screen-like member (7) are directed downwards towards and preferably into the lower space (8),
wherein the lower space (8) via a through-flow gap (11) at an outer side of the downwardly directed portions (7a) of the screen-like member (7) communicates with the supply space (4) such that granules (2) can flow from said supply space down into the lower space (8), and
wherein the lower space (8) via a discharge gap (12), which relative to a centre line (C) along the shaker (1) is located at an inner side of said downwardly directed portions (7a), communicates with the outfeed opening (6) such that granules (2) via the discharge gap (12) can pass from the lower space (8) to the outfeed opening (6),
characterized in that the screen-like member (7) is mounted movable in vertical direction relative to the lower parts (5) of the shaker (1) which define the lower space (8) or vice versa, for being able to set the screen-like member (7) such that its downwardly directed portions (7a) are set at different distances (e.g. A or B) from the bottom (9) of the lower space (8), whereby it is achieved that said lower space (8) can be brought to contain different amounts (e.g. M1 or M2) of granules (2).

2. Shaker according to claim 1, characterized in that the downwardly directed portions (7a) of the screen-like member (7) are directed downwards towards and preferably into the lower space (8) such that within an imaginary vertical plane (P) and beneath the discharge gap (12) there is defined an inner pocket (8a) of said lower space (8) in which inner pocket (8a) an amount (M1 or M2) of granules (2) is collected for sprinkling on one and the same sprinkling occasion.

3. Shaker according to claim 1 characterized in that a flow resisting member (24) is provided to prevent granules (2) from being thrown out of the lower space (8) upwards into the through-flow gap 11.

4. Shaker according to claim 3, characterized in that the flow resisting member (24) is located on an inwardly directed wall portion (25) of the upper parts (3) of the shaker (1) such that said flow resisting member (24) along with said inwardly directed wall portion (25) defines a downwards towards the through-flow gap (11) open, but upwards closed space (26) above said through-flow gap (11).

5. Shaker according to claim 1, characterized in that the shaker (1) has spreading surfaces and/or spreading members (7d and/or 7e and/or 7f and/or 21) which are provided to spread or scatter granules (2) in an outwards direction relative to the centre line (C) of the shaker (1).

6. Shaker according to claim 1, characterized in that the spreading surfaces and/or spreading members (7d and/or 7e and/or 7f and/or 21) are located on the screen-like member (7) and/or on the lower parts (5) of the shaker (1) beneath said screen-like member (7).

7. Shaker according to claim 6, characterized in that the screen-like member (7) has at least one spreading member (7d and/or 7e and/or 7f and/or 21) guiding granules (2) to pass through peripheral portions (PD) of the ouffeed opening (6).

8. Shaker according to claim 7, characterized in that spreading members are defined by an annular flange (7f) which is directed downwards from the screen-like member (7) and which direct the granules (2) to flow through said peripheral portions (PD) of the outfeed opening (6).

9. Shaker according to claim 8, characterized in that the annular flange (7f) has an outer diameter which is somewhat smaller than the diameter of the outfeed opening (6).

10. Shaker according to claim 8, characterized in that in said peripheral portions (PD) of the outfeed opening (6) and/or above and/or beneath said peripheral portions (PD) through which granules (2) are brought to pass, there is located at least one spreading member (21) spreading the granules (2) at least in obliquely outwards and obliquely inwards directions.

11. Shaker according to claim 10, characterized in that a rim of spreading members (21) are located in said peripheral portions (PD) through which the granules (2) pass, and that this rim has a diameter which is larger than the diameter of the annular flange (7f) but smaller than the diameter of the outfeed opening (6).

12. Shaker according to claim 10, characterized in that the spreading members (21) are conical in shape and have their points facing upwards.

13. Shaker according to claim 12, characterized in that the conical members (21) form part of a ring (22) which is located in the outfeed opening (6).

14. Shaker according to claim 6, characterized in that the spreading members (7d and/or 7e and/or 7f) on the screen-like member (7) are provided to limit the movement of the granules (2) in inwards direction when said granules (2) are thrown out of the lower space (8) by imparting a sprinkling movement in upwards direction to the shaker (1), and that the screen-like member (7) is provided to affect the granules (2) in downwards direction towards spreading members (21) beneath the screen-like member (7) when the shaker (1) is imparted a sprinkling movement in downwards direction.

15. Shaker according to claim 1, characterized in that the shaker (1) consists of only three parts, namely an upper part (3) with the supply space (4), an annular member (16) defining the lower space (8), said annular member (16) being removably attached to said upper part (3), and a screen-like member (7) which is removably attached to the annular member (16).

16. Shaker according to claim 1, characterized in that the screen-like member (7) can be set in vertical direction by imparting thereto a rotary motion relative to lower parts (5) defining the lower space (8), of the shaker (1).

17. Shaker according to claim 16, characterized in that the screen-like member (7) and the lower parts (5) of the shaker (1) defining the lower space (8) are provided with co-operating stepping members (14, 15) which permit step-wise rotation of the screen-like member (7) to different definite positions relative to said lower parts (5) of the shaker (1).

18. Shaker according to claim 16, characterized in that the lower parts (5) of the shaker (1) defining the lower space (8), have at least one helical groove (13) which is rotatably engaged by the screen-like member (7).

19. Shaker according to claim 16, characterized in that the lower parts (5) of the shaker (1) defining the lower space (8), are or include an annular member (16) which is removably attached to upper parts (3) of the shaker (1), and that the screen-like member (7) on an upper side has at least one flange (17) which is accessible when the annular member (16) has been removed from the upper parts (3) of the shaker (1) along with the screen-like member (7) for being able to grip or engage the flange (17) and thereby be able to rotate the screen-like member (7) relative to the annular member (16).

20. Shaker according to claim 16, characterized in that there are downwardly directed means on the screen-like member (7) which can be grasped or engaged through the outfeed opening (6) for rotation of the screen-like member (7) relative to the lower parts (5) of the shaker (1) defining the lower space 8.

21. Shaker according to 1, characterized in that the lower space (8) is limited in inwards direction by an inner wall (18) of which an upper edge (19) defines upper portions of the outfeed opening (6), and that at least lower portions of an inner side (20) of the inner wall (18), closest to a bottom (9) of the lower space (8), are directed obliquely upwards/inwards.

22. Shaker according to claim 1, characterized in that the shaker (1) has a setting scale showing in which height position the screen-like member (7) is set relative to the lower space (8) and/or that the shaker (1) has a direction indicator showing in which direction a member (16) of the shaker (1) shall be screwed or rotated for raising or lowering said member (16).
